(19) United States
(12) Patent Application Publication
(10) Pub. No.: US 2019/0362323 A1
(43) Pub. Date: Nov. 28, 2019

(54) SOCIAL NETWORK SITE THAT GIVES USERS THE ABILITY TO SEND AND RECEIVE CRYPTOCURRENCIES FROM ONE USER TO ANOTHER

(71) Applicant: DeAngelo Singleton, Hollister, CA (US)

(72) Inventor: DeAngelo Singleton, Hollister, CA (US)

(73) Assignee: DeAngelo Singleton Singleton, Hollister, CA (US)

(21) Appl. No.: 16/418,954

(22) Filed: May 21, 2019

Related U.S. Application Data
(60) Provisional application No. 62/674,740, filed on May 22, 2018.

(51) Int. Cl. G06Q 20/06; G06Q 20/38; G06Q 50/00

(52) U.S. Cl. CPC G06Q 20/0658; G06Q 50/01; G06Q 20/389

(57) ABSTRACT

Social networking systems that includes the use of blockchain technology to transfer financial value between different platforms, the use of blockchain technology to receive financial value, and/or the use of blockchain technology to send financial value. One embodiment also includes the use of blockchain technology to enable users of social networking systems to transfer financial value between each other.

### CROSS-REFERENCE TO RELATED DOCUMENTS

The present application claims priority to provisional patent application No. 62/674,740, filed on May 22, 2018, the disclosure of which are incorporated herein at least by reference.

### BACKGROUND OF THE INVENTION

### 1. Field of the Invention

The various embodiments described herein relate to social networking systems. In particular, the embodiments relate to blockchain technology being leveraged by social networking systems to provide financial value. Common forms of financial value that are based on blockchain technology include but are not limited to cryptocurrencies and digital assets.

### 2. Description of Related Art

Social networking systems have evolved tremendously since 2003. They currently enable users to interact with each other in several different ways. For example, a social networking system gives users the ability to send private messages, comment on post, like post, view videos, post pictures, and more. Despite all the evolutionary processes of social networking systems over the years, there are still limitations. One of the current restrictions of social networking systems is that the ability to send and receive financial value is limited to government-based currencies (e.g., US Dollar, Japanese yen, British pound).

Therefore, what is clearly needed is a financial solution that utilizes blockchain technology to solve the problem mentioned above.

### BRIEF SUMMARY OF THE INVENTION

In one embodiment of the invention a social networking system that leverages blockchain technology to provide financial value is provided comprising the use of blockchain technology to transfer financial value between different platforms, the use of blockchain technology to receive financial value, and the use of blockchain technology to send financial value.

Also, in one embodiment social networking systems leverage blockchain technology to enable users to transfer financial value between each other. A common way to leverage blockchain technology includes, but is not limited to cryptocurrencies, also known as digital assets.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates a social networking system that integrates blockchain based wallets, which gives the users the ability to send blockchain based financial value in accordance to one or more embodiments.

FIG. 2 illustrates an embodiment of a blockchain based wallet for social networking systems that would enable the users to store different types of blockchain based financial value and send them to another blockchain based wallet that is on a different platform than the social networking system. This can work in conjunction with FIG. 1.

FIG. 3 is a process flow chart illustrating steps of social networking systems that utilize blockchain based technology to transfer financial value in one embodiment of the invention.

### DETAILED DESCRIPTION OF THE INVENTION

The inventor provides a unique integration of social networking systems and blockchain based technology to transfer financial value. The new system incorporates systems and methods to store, transfer, and receive financial value with social networking systems by utilizing blockchain based technology. The present invention is described in enabling detail in the following examples, which may represent more than one embodiment of the present invention.

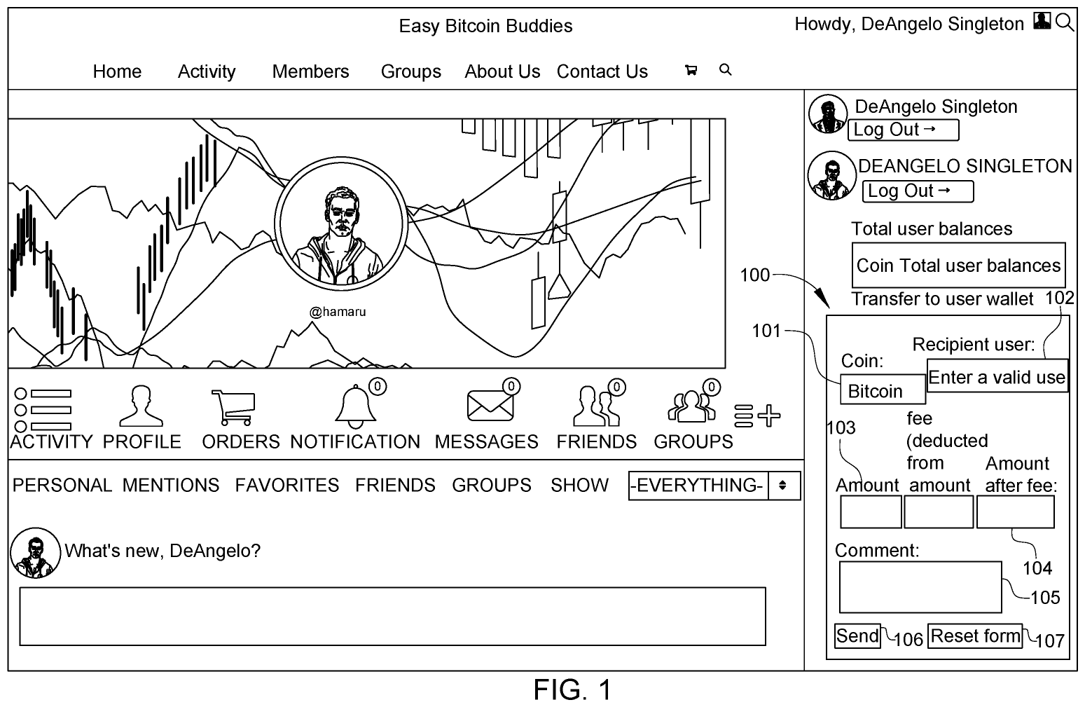

FIG. 1 illustrates a social networking system that integrates blockchain based wallets 100, which gives the users the ability to send blockchain based financial value 101 in accordance to one or more embodiments. These wallets may be connected to a blockchain through different forms of computer code (e.g., Javascript, XML, HTML, etc.). Both skilled and unskilled individuals may quickly realize that a set of characters such as numbers, letters, both, or more are used to establish a unique address for users, which is where blockchain based financial value is stored, sent, and received in an embodiment of the invention.

Social networking systems can contain different types of blockchain based financial value (e.g., Bitcoin, Litecoin, XRP, Cryptocurrencies, units that convert into financial value, etc.) 101. Systems and methods would then be used so that users of social networking systems can send blockchain based financial value to other users of their choice 102. Users of one or more embodiments of FIG. 1 can choose the amount of blockchain based financial value they want to send 103 and can see the amount being sent after any associated fees 104. One or more embodiments of this invention may contain comments 105, a way to finalize the sending of blockchain based financial value 106 and may contain a way to edit the information provided by the sender before finalizing their decision 107 according to an embodiment of the invention.

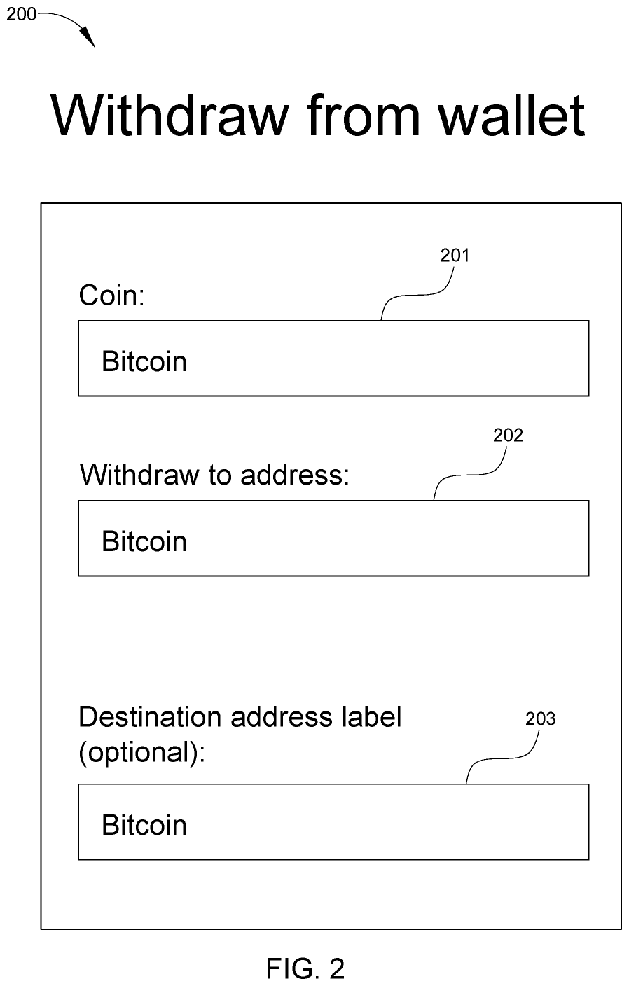

FIG. 2 illustrates an embodiment of a blockchain based wallet for social networking systems that would enable the users to store different types of blockchain based financial value 201 and send them to another blockchain based wallet that are on a different platform than the social networking system 202. This may work in conjunction with FIG. 1 according to one or more embodiments of this invention. Users of social networking systems may be able to select established destination addresses for varies types of blockchain based financial value (e.g., Bitcoin, Litecoin, XRP, Cryptocurrencies, units that convert into financial value, etc.) 203 according to an embodiment of the invention.

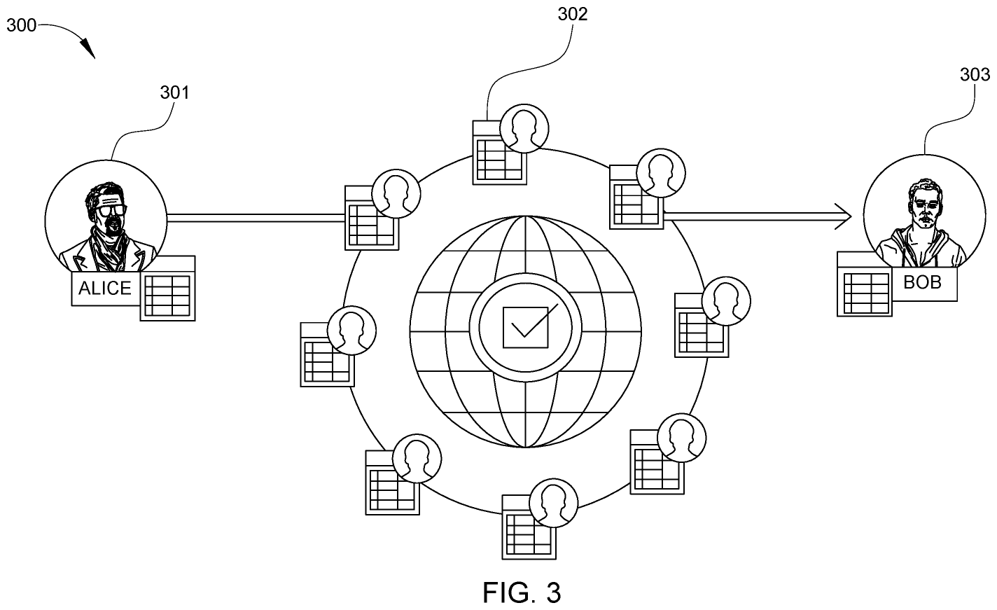

FIG. 3 is a process flow chart illustrating steps of social networking systems that utilize blockchain based technology to transfer financial value 300. According to one embodiments of the invention, the flow chart illustrates a user account of a social networking system, which may have various collected data about the user 301. This data may contain ways to identify the user, various blockchain based financial balances, and information needed to send and receive blockchain based financial value (in relation to FIG. 1 and FIG. 2) according to an embodiment of the invention.

As further illustrated in FIG. 3, the social networking system may connect the user to a storage of information which may connect to a blockchain 302. A blockchain is a growing list of records, referred to as blocks, and are linked using cryptography. Each block contains a cryptographic hash of the previous block, transaction data, and a timestamp. The use of blockchain technology will enable all transactions to be recorded in a permanent way, which is resistant to modification according to an embodiment of the invention.
FIG. 3 continues to illustrate in this embodiment of the invention that once a user of a social networking system sends their intent to the blockchain 301, the blockchain will then process the information as it relates to all other users of the platform 302, and then finalize the transaction by connecting with the receiver 303. Once the receiver obtains financial value from the sender 301, their balance information will be updated, and the transaction will be recorded by the blockchain 302 according to an embodiment of the invention.
It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

1. Social networking systems comprising:
a. The use of blockchain technology to transfer financial value between different platforms;
b. The use of blockchain technology to receive financial value;
c. The use of blockchain technology to send financial value.

2. Social networking systems that leverage blockchain technology to enable users to transfer financial value between each other.
